(19) United States
(12) Patent Application Publication
(10) Pub. No.: US 2010/0127069 A1
(43) Pub. Date: May 27, 2010

(54) APPARATUS AND METHOD OF PERFORMING FINANCIAL BUSINESS TRANSACTIONS

(76) Inventor: DAVID HENTON, SR., Navarre, FL (US)

Correspondence Address: DAVID HENTON, SR., 7002 TURNBERRY CIRCLE, NAVARRE, FL, 32566, US

(21) Appl. No.: 12/277,945

(22) Filed: Nov. 25, 2008

(51) Int. Cl. G06Q 40/00

(52) U.S. Cl. 235/379

(57) ABSTRACT

An apparatus and method of performing financial business transactions is disclosed. The apparatus includes a Point-of-Service (POS) terminal for providing Automated Teller Machine (ATM) functions; a motorized card terminal for providing KIOSK functions; and at least one biometric device for authenticating the KIOSK functions. The apparatus can further include a LCD touch screen for providing both digital advertising for vendors and instructional information for the ATM functions. The LDC screen also allows a user to complete the KIOSK functions. The at least one biometric device is a palm vein scanner and a fingerprint scanner.

### FIELD OF THE INVENTION

This invention relates to financial business terminals. More particularly, the present invention relates to an apparatus and method of performing ATM transactions using a first terminal and KIOSK transactions using a second terminal, the second terminal including biometric devices for authorizing the KIOSK transactions.

### BACKGROUND OF THE INVENTION

Automated banking machines are well known. A common type of automated banking machine used by consumers is an Automated Teller Machine (“ATM”). Introduced in the mid-1970s, ATMs enable customers to carry out a variety of banking transactions by interacting with the machine rather than a human teller. Examples of banking transactions that are commonly carried out using ATMs include cash withdrawals, deposits, account balance inquiries and funds transfers. ATMs increasingly are being installed in places where consumers may want access to their money, such as supermarkets, convenience stores, and transportation terminals. By 2007, there were approximately 415,000 ATMs in the United States, almost five times the number of bank and thrift branches in 2006.

Other types of machines allow customers to carry out financial transactions. KIOSK machines provide services via a card similar to the ATM. Differentiating an ATM from a KIOSK is not always easy. In general, KIOSKS involve non-cash dispensing functions, such as bill payment, pay day loans, and debit card dispensing. Further, with the growth of online banking, electronic payments and funds transfer, as just two examples, can be made on a computer via the Internet without usage of an ATM or KIOSK machine.

That said, customers must still access more than one machine (or financial institution) to handle all of their financial transactions needs. Customers must go to a financial institution to cash their checks, a Post Office to pay at least some of their bills via mail, an ATM machine to withdraw funds, and a KIOSK to do non-cash transactions. The problem is even more acute for customers who are not affiliated with any financial institutions, are vacationing at a distant place but must still pay their bills on-time, or do not have the means or resources to travel to multiple locations to complete their financial needs.

What is needed is a multi-functional machine to handle financial transactions, including ATM and KIOSK functions, without the limitations and drawbacks of current transaction machines or devices.

### SUMMARY OF THE INVENTION

The present invention is directed to an apparatus and method of performing financial business transactions. In one embodiment of the present invention, an apparatus for performing financial business transactions is disclosed. The apparatus comprises a Point-of-Service (POS) terminal for providing Automated Teller Machine (ATM) functions; a motorized card terminal for providing KIOSK functions; and at least one biometric device for authenticating the KIOSK functions. The at least one biometric device comprises a palm vein scanner and a fingerprint scanner.

According to one embodiment, the POS terminal is a POS reader. The POS reader comprises a LCD display, a magnetized card reader, an encrypted keypad, and an integrated thermal printer. The POS reader further includes a telephone modem and communication protocol.

According to one embodiment, the motorized card terminal comprises a motorized card reader. The motorized card reader reads a magnetic stripe and writes to a Smart Card chip.

The apparatus of the present invention can also comprise a LCD touch screen for providing digital advertising for vendors and instructional information for the ATM functions. The LCD screen also allows a user to complete the KIOSK functions.

The apparatus of the present invention can further comprise a dual-purpose scanner for scanning checks and personal identification. The apparatus can also comprise a bill acceptor device for accepting bills; a card dispenser device for selling and loading per-paid debit cards; an electronic digital camera for taking a picture of a user of the KIOSK functions; and cash dispense tray for a user of the ATM functions.

In another embodiment of the present invention, a method of performing financial business transactions is disclosed. The method comprises providing ATM functions via a POS terminal; providing KIOSK functions via a motorized card terminal; and authenticating a user of the KIOSK functions via at least one biometric device.

In one embodiment, the method further comprises providing digital advertising for vendors and instructional information for the ATM functions via a LCD touch screen. The LCD touch screen is also used for completing the KIOSK functions. The method can also comprise scanning checks and personal identification via a dual-purpose scanner. The method can further comprise accepting bills via a bill receptor device; selling and loading pre-paid debit cards via a card dispenser device; taking a picture of a user of the KIOSK functions via an electronic digital camera; and dispensing cash for a user of the ATM functions via a cash dispense tray.

### BRIEF DESCRIPTION OF THE DRAWINGS

FIG. 1 shows a perspective view of an apparatus for performing financial business transactions, in accordance with one embodiment of the present invention.

FIG. 2 shows a flow chart of a method of performing financial business transactions, in accordance with one embodiment of the present invention.

FIG. 3 shows a flow chart of a method of performing a check cashing operation, in accordance with one embodiment of the present invention.

### DETAILED DESCRIPTION OF THE PREFERRED EMBODIMENTS

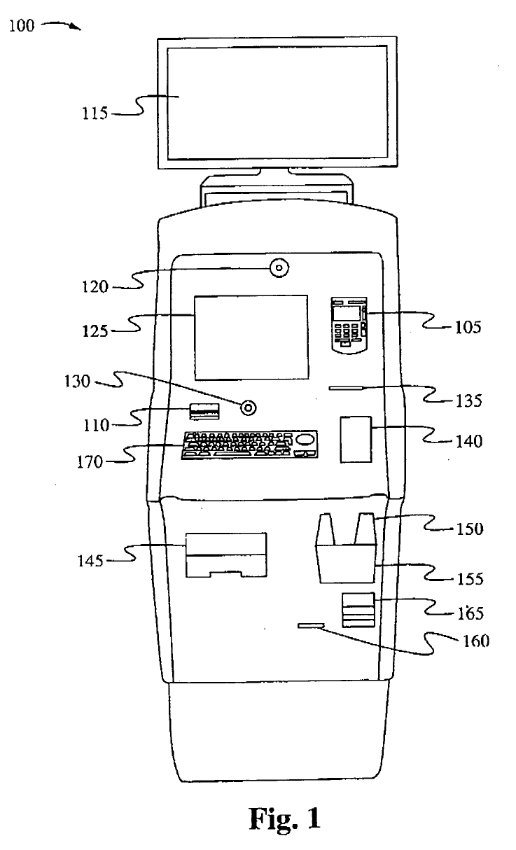

FIG. 1 shows a perspective view of an apparatus 100 for performing financial business transactions, in accordance with one embodiment of the present invention. The apparatus 100 comprises a Point-of-Service (POS) terminal 105 for providing Automated Teller Machine (ATM) functions; a motorized card terminal 110 for providing KIOSK functions; and at least one biometric device for authenticating the KIOSK functions. The at least one biometric device can be at least one of a palm vein scanner 140 and a fingerprint scanner 130.

In one embodiment, the POS terminal 105 is a POS reader and comprises a LCD display, a magnetized card reader, an encrypted keypad, and an integrated thermal printer. The POS reader also includes a telephone modem and communication protocol. The POS reader may also be Payment Card Industry (PCI) compliant. In addition to providing traditional ATM transactions, the POS reader can also include software that provides one or more of the following functions: time management for employers, pre-paid card activation, gift and loyalty programs, money transfers, phone card activation, and check image deposits by participating financial institutions.

The POS terminal 105 can also be used for time control management purposes by employers. For example, the POS terminal 105 can be used as a time clock for employees of the employer and can print out employee time management reports for an accounting of employee time. In operation, an employee swipes an employer issued magnetic stripe card with the employee's information on it. The POS terminal 105 logs the time and employee information for the start of a shift and at the end of the shift. The employer or merchant can then print out several different reports for accountability. This can include daily shift reports, weekly shift reports and/or monthly shift reports.

Furthermore, the POS terminal 105 can also automatically activate certain cards, such as prepaid cards, gift cards and loyalty cards, when a customer swipes one of these cards, through the POS terminal 105, that has been purchased by the customer. Also, many cards offer “reloading” of funds on the cards and this reloading can be done using the POS terminal 105.

Still referring to FIG. 1, the motorized card terminal 110 is a motorized card reader that functions as a credit card and debit card reader. The motorized card reader, which may be PCI approved, combines the technologies of reading a magnetic strips with reading and writing to a Smart Card chip in one step.

The palm vein scanner 140, used during a customer identification registration process, takes a picture of the veins in the palm of the hand of a person. The palm vein scanner 140 can be used for identifying the person by matching the scanned image. Like the palm vein scanner, the fingerprint scanner 130 is also used during a customer identification process.

In one embodiment, the apparatus 100 further includes a LCD touch screen 125 for providing digital advertising for vendors and instructional information for the ATM function. The LCD touch screen 125, which can also be used to complete KIOSK functions, includes a metal enclosure with a USB interface connection. Advertising for the LCD touch screen 125 can be changed from a remote facility by uploading different ads and screen content. The LCD touch screen 125 can also be used by a customer to print out specific coupons that interest the customer.

In one embodiment, the apparatus 100 also includes a dual-purpose scanner for scanning checks and personal identification. The dual purpose scanner comprises a photo identification scanner 150 and a check scanner 155. As an example, if a customer chooses to perform a “check cashing” operation of the apparatus 100, the customer is requested to scan his Drivers License or ID card using the identification scanner 150 and, after the identification process is completed, the customer scans his check using the check scanner 155.

The apparatus 100 can also include a bill acceptor device 165 for accepting bills. A customer using this application can make both regular bill payments and same day payments via the bill acceptor device 165. As an example of using the bill payment application, a customer selects “bill payment” from the LCD touch screen 125. The customer is then prompted to read Terms and Conditions and if the customer approves of the Terms and Conditions (and any fees) he then selects to move on to a next screen. (Optionally, the customer can elect to cancel the transaction at any time.) The customer is asked to register and identify his name and address and this information is then encrypted and sent to a server and stored in a safe location with PCI compliance. After identification is verified the customer is then prompted to select the state that his Biller (e.g., a cellular phone company or a utility company) is from and then selects the name of the Biller. The customer is prompted to enter his account number and place his bill into the bill acceptor device 165. Once the account number is verified, the customer is requested to pay his bill by cash, credit card or check.

The apparatus 100 can also include a card dispenser device 160 for selling and loading pre-paid debit cards. The card dispenser device 160 sells and loads pre-paid cards with the amount of the check cashed, with cash amounts and by credit card amounts. For example, if a customer performs a check processing application the apparatus 100 may issue a debit card via the card dispenser device 160 for the amount of the check (less a fee), rather than issue cash for the amount being processed.

The apparatus 100 can further include an electronic digital camera 120 for taking a picture of a user of the KIOSK functions; a cash dispense tray 145 for dispensing cash for a user of the ATM functions; a keyboard 170 to enable a customer to enter, when requested, specific information in various application; and a topper LCD screen 115 for providing advertising. The topper LCD screen 115 can be used for both local and national advertising for vendors who want to advertise in any location where the apparatus 100 is located. Also, the apparatus 100 can include a receipt and coupon printer 135 that prints receipts for both the ATM applications and the KIOSK applications. The receipt and coupon printer 135 can also print advertisements on the reverse side of a printer paper for certain vendors.

In use of one embodiment of the ATM functions of the present invention, a customer passes his debit card or credit card through the POS terminal 105. The customer then elects a language, such as English or Spanish, and enters his private pin number. The customer then selects the type of transaction that he wants to do. The transaction can be, for example, a cash transaction, a billing inquiry, or a transfer funds transaction. If the cash transaction is selected, the apparatus 100 displays the fees involved, if any, and offers a selection to “cancel” or “continue”. If the customer chooses to continue, he selects an amount up to a limit. When the customer selects an amount the information is sent with the proper encryption to a server that is electronically coupled to the apparatus 100 and the server passes the information to a financial institution for approval or disapproval. If approved, the apparatus 100 dispenses the amount requested. If, for whatever reason—bill jambs, communication failure or electrical failure—the total amount is not dispensed, the apparatus 100 sends a reversal message to reverse the amount that was not dispensed and for the financial institution to reimburse the customers account.

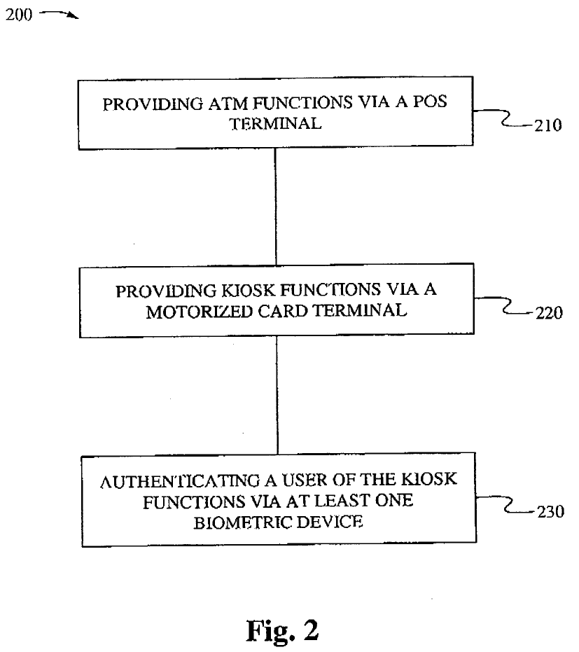

FIG. 2 shows a flow chart 200 of a method of performing financial business transactions, in accordance with one embodiment of the present invention. In 210, ATM functions are provided via a POS terminal. In 220, KIOSK functions are provided via a motorized card terminal. In 230, a user of the KIOSK functions is authenticated via at least one biometric device.

The method, as described in the flow chart 200 of FIG. 2, can further include providing digital advertising for vendors and instructional information for the ATM functions via a LCD touch screen, wherein the LCD touch screen is also used for completing the KIOSK functions. The method can also include scanning checks and personal identification via a dual-purpose scanner, accepting bills via a bill acceptor device and selling and loading pre-paid debit cards via a card dispenser device. The method can also include taking a picture of a user of the KIOSK functions via an electronic digital camera and dispensing cash for a user of the ATM functions via a cash dispense tray.

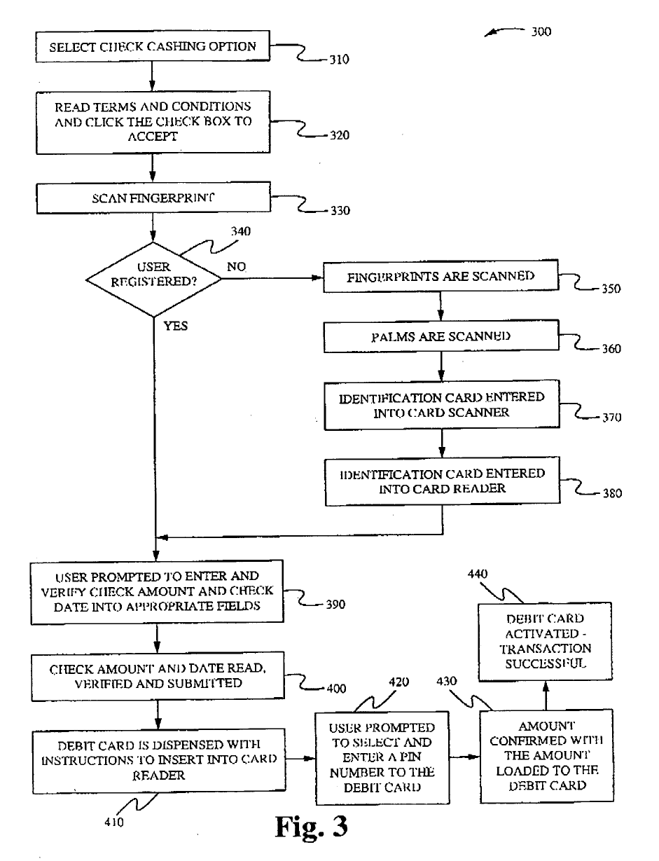

FIG. 3 shows a flow chart 300 of a method of performing a check cashing operation, in accordance with another embodiment of the present invention. In 310, a user selects the check cashing option on the LCD touch screen 125 (FIG. 1) of the apparatus 100 (FIG. 1). In 320, the user reads the Terms and Conditions and clicks a “Check” box to accept. In 330, the user's fingerprints are scanned. In 340, if the user is not a registered user, the user is prompted to register. In 350, as part of the registration, fingerprints of the user are scanned. In 360, palms of the user are scanned. In 370, an identification card of the user is entered in to the card scanner 150 (FIG. 1) and, in 380, the identification card is entered into the card reader 110 (FIG. 1). Once the user is registered—or had previously registered—the user is prompted to enter and verify the check amount and check date into appropriate field, as shown in 390. In 400, the check amount and date are read, verified and submitted. In 410, a debit card is dispensed with instructions to insert the card into the card reader 110 (FIG. 1). In 420, the user is prompted to select and enter a PIN number to the debit card. The amount loaded to the debit card is confirmed with the user, as shown in 430. In 440, the debit card is activated and the transaction is successful. The user can then use the card for purchases or to withdraw cash from any ATM machine, from the apparatus 100 (FIG. 1), or from anywhere that debit cards are accepted. The user can also, among other things, check the balance on the card by using the POS terminal 105 (FIG. 1) and requesting a balance inquiry. Alternatively, in the method as described in the FIG. 3 above, rather than load the amount to a debit card, as described in the steps 410, 420, 430 and 440, the amount can be dispensed as cash.

The apparatus and method of the present invention provides convenient financial and retail services to any customer who wants to use it for their personal financial or business transactions. The present invention benefits local populations and travelers or tourists who need to take care of personal private transactions. It can also boost sales of local businesses and products as well as national businesses and products by participating in the advertisement applications of the present invention.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention

What is claimed is:

1. An apparatus for performing financial business transactions comprising:
a. a POS terminal for providing ATM functions;
b. a motorized card terminal for providing KIOSK functions; and
c. at least one biometric device for authenticating the KIOSK functions.

2. The apparatus of claim 1 wherein the POS terminal is a POS reader.

3. The apparatus of claim 2 wherein the POS reader comprises a LCD display, a magnetized card reader, an encrypted keypad, and an integrated thermal printer, the POS reader including a telephone modem and communication protocol.

4. The apparatus of claim 1 wherein the motorized card terminal comprises a motorized card reader.

5. The apparatus of claim 4 wherein the motorized card reader reads a magnetic stripe and writes to a Smart Card chip.

6. The apparatus of claim 1 wherein the at least one biometric device comprises at least one of: a palm vein scanner and a fingerprint scanner.

7. The apparatus of claim 1 further comprising a LCD touch screen for providing digital advertising for vendors and instructional information for the ATM functions, and for completing the KIOSK functions.

8. The apparatus of claim 7 further comprising a dual-purpose scanner for scanning checks and personal identification.

9. The apparatus of claim 8 further comprising a bill acceptor device for accepting bills.

10. The apparatus of claim 9 further comprising a card dispenser device for selling and loading pre-paid debit cards

11. The apparatus of claim 10 further comprising an electronic digital camera for taking a picture of a user of the KIOSK functions.

12. The apparatus of claim 11 further comprising a cash dispense tray for a user of the ATM functions.

13. The apparatus of claim 12 further comprising a topper LCD screen for providing advertising.

14. A method of performing financial business transactions comprising:
a. providing ATM functions via a POS terminal;
b. providing KIOSK functions via a motorized card terminal; and
c. authenticating a user of the KIOSK functions via at least one biometric device.

15. The method of claim 14 wherein the POS terminal is a POS reader.

16. The method of claim 15 wherein the POS reader comprises a LCD display, a magnetized card reader, an encrypted keypad, and an integrated thermal printer, the POS reader including a telephone modem and communication protocol.

17. The method of claim 14 wherein the motorized card terminal comprises a motorized card reader.

18. The method of claim 17 wherein the motorized card reader reads a magnetic stripe and writes to a Smart Card chip.

19. The method of claim 14 wherein the at least one biometric device comprises at least one of: a palm vein scanner and a fingerprint scanner.

20. The method of claim 14 further comprising providing digital advertising for vendors and instructional information for the ATM functions via a LCD touch screen, wherein the LCD touch screen is also used for completing the KIOSK functions.

21. The method of claim 20 further comprising scanning checks and personal identification via a dual-purpose scanner.

22. The method of claim 21 further comprising accepting bills via a bill acceptor device.

23. The method of claim 22 further comprising selling and loading pre-paid debit cards via a card dispenser device.

24. The method of claim 23 further comprising taking a picture of a user of the KIOSK functions via an electronic digital camera.

25. The method of claim 24 further comprising dispensing cash for a user of the ATM functions via a cash dispense tray.

26. The method of claim 25 further providing advertising via a topper LCD screen.
